(19) United States
(12) Patent Application Publication
(10) Pub. No.: US 2021/0187890 A1
(43) Pub. Date: Jun. 24, 2021

(54) VERTICAL BOX BALER AND METHOD OF OPERATING IT

(71) Applicant: Hermann Schwelling, Salem (DE)

(72) Inventor: Hermann Schwelling, Salem (DE)

(21) Appl. No.: 17/113,360

(22) Filed: Dec. 7, 2020

(30) Foreign Application Priority Data
Dec. 19, 2019 (DE) 102019135166.9
Mar. 6, 2020 (DE) 102020106156.0

(51) Int. Cl. B30B 9/30; B65B 13/04; B65B 13/20

(52) U.S. Cl. CPC B30B 9/301; B65B 13/20; B65B 13/04; B30B 9/3032

(57) ABSTRACT

In order to be able to attach an automatic rear-end filling device (20) to a vertically operating box baler (1), which does not increase the height requirement for such an automated vertical box baler (1) too much and at the same time permits batchwise operation, a collecting trolley (SW) filled with loose material (P) is automatically lifted by means of a corresponding lifting/pivoting device (20) and dumped in a storage container (21) at the e.g. rear wall and from there it is pushed diagonally upwards in the direction of movement (24′) through a filling opening (2.2a) into the interior of the press box (2) by means of a storage pusher (24).

### I. FIELD OF APPLICATION

The invention relates to box balers, in which the material to be pressed is pressed by a press stamp against a fixed abutment, namely the end wall of the press box. The invention relates specifically to vertically acting box balers, in which the press stamp moves up and down, usually vertically, and presses the material to be pressed against the bottom of the press box, which is open at the top and only closed by the press stamp.

### II. TECHNICAL BACKGROUND

The one or both parallel acting press stamps are mostly actuated by hydraulic cylinders.

Such vertically acting box balers are often used when the amount of material to be baled is low.

Filling and emptying is often carried out from the front side of the baler, which has a closable filling opening in the upper part of its front wall, through which the loose material to be pressed—e.g. empty cartons or empty plastic bottles or beverage cans—is manually filled into the press box when the press stamp is in the upwardly retracted starting position, i.e. above the filling opening.

When a bale has built up to the desired height after a certain number of pressing strokes, it can be removed via the closable removal opening under the filling opening in the front wall.

In order to reduce the manual effort and also to increase the process flow of such a vertically acting box baler, it is known that such box balers are filled automatically by a conveyor belt that transports loose material placed on it to the filling opening and ejects it through this opening into the bale chamber when the press stamp is in its initial position above it. The conveyor belt usually runs at an angle from bottom to top to the filling opening, so that the loose material can easily be placed on the low lying end of the conveyor belt.

As such an automatic filling device would be in the way when emptying the box baler if the filling opening and therefore also the filling device were still located at the front side of the baler, in these cases the filling opening is usually located at the rear opposite the front side.

However, such a conveyor requires a lot of floor space in addition to the rest of the vertical box baler, whose principal advantage is that it requires very little floor space, thus losing its main advantage. In addition, a vertically operating box baler equipped with such a conveyor cannot be placed at a small distance in front of a wall.

In addition to that, it is often the case-especially with cardboard boxes or empty beverage cans as pressed goods-that the pressed goods are collected away from the baler in collecting trolleys open at the top, and the filled collection trolleys are then pushed to the baler. The collecting trolley should then be emptied as completely as possible into the baler so that the empty trolley is immediately available again.

The material to be pressed is thus accumulated in batches at the baler.

### III. DESCRIPTION OF THE INVENTION

### a) Technical object

It is therefore the object according to the invention-especially in the case of batchwise accumulated material to be pressed-to provide a vertically acting box baler with an automatic filling device, which requires the smallest possible footprint, is simple, so that it can be manufactured cost-effectively and yet functionally reliable, and requires only the least possible manual effort for operation, as well as a corresponding operating method for operating such a baler.

### b) Solution of the object

This object is solved by the characteristics of claims 1 and 15. Advantageous embodiments result from the subclaims.

A standard vertical box baler comprises a bale boxwith a bottom and side walls rising upwards, usually vertically, from its circumferential edges, which form the bale box, and a press stamp which can be moved up and down in the bale box, usually by means of one or more parallel, usually hydraulically operated, working cylinders which can be moved with great force.

The bottom and thus the inner horizontal cross-section of the bale box is usually approximately rectangular, so that there are four side walls arranged in a rectangle when viewed from above, which are usually adjacent to each other, i.e. they surround the bale chamber continuously in the horizontal circumferential direction. The side walls are not exactly parallel to each other, but are slightly further apart from each other from the back to the front, towards the removal opening, in order to facilitate removal of the finished bale.

However, other forms of horizontal cross-sections of the press box are also possible, for example a round cross-section with the result that there is then a single cylindrical side wall, which should, however, be covered by the mentioned several side walls used here.

One of the side walls, which is called the front wall, is usually designed as a completely openable removal door for removing the finished bale, and in its upper part, especially its upper half, there is a frontal filling opening that can be closed by a filling flap.

The upper edge of the filling opening is usually located below the pressing surface, the underside of the press stamp retracted into its upper end position, the starting position. The lower edge of the filling opening is usually still above the height of the upper edge of the removal opening, but at most 10 cm, better 5 cm below this height.

If there is an automatic—i.e. at least motor-driven and manually or by means of a control system—filling device, this filling opening is usually not located in the front wall, but in one of the other side walls, usually in the rear wall opposite the front wall. By means of such an automatic filling device, the loose material to be pressed, which is placed on top of or inside the press box, is not only transported up to the filling opening, but also through this opening into the press box, and for this purpose, if necessary, pushed through the filling opening by the automatic filling device.

There is also a control system-usually electric or electronic—which controls the entire baler, especially all moving parts of the baler.

This control system is supplemented by a corresponding sensor system, which detects in particular the open or closed position of the doors or flaps closing the openings of the bale box, the position of the press stamp and, if necessary, all other relevant physical parameters on the baler.

According to the invention, this object is solved in such a vertically acting box-type baler by first of all designing the automatic filling device for batchwise automatic filling of this baler, i.e. its pressing box.

This means that the batched material can be pressed very quickly using the baling press, which is based on the invention.

(Volume of Storage Container:)

In particular, this automatic filling device comprises a storage container for receiving loose material to be pressed, the volume of which—in case of variable volume its maximum volume—is sufficient to receive a complete batch—the maximum volume of which is predetermined—of, in particular, loose material to be pressed. The specified batch volume is usually the volume of a collecting trolley, in which the loose material to be pressed is collected at the place where it is produced.

This has the advantage that the entire content of a filled collecting trolley can be automatically emptied into this automatic filling device at once, saving a lot of time.

For this purpose, the filling device, especially its storage container, preferably has a filling opening, especially in the upper area, so that the loose material to be pressed can fall into the storage container from above due to gravity. In particular such a filling opening is formed in the upper side of the storage container, whereby as simplest solution the upper side can be completely open as filling opening.

Especially through such a large-surface filling opening, loading of the storage container is very easy and fast.

To ensure that the loose material to be pressed can be moved as easily as possible from the storage container to the filling opening of the press chamber, the storage container is connected to the filling opening or can at least be brought into contact with it.

This does not necessarily require a contact between the storage container and the filling opening, but only that the storage container and especially its discharge opening in the direction of the filling opening is or can be moved in a closely adjacent position to the filling opening.

The bottom of the storage container is at the level of the lower edge of the filling opening or slightly above it and reaches close to it by at least 2 cm or at least 1 cm or even into the filling opening.

This allows the material to be pressed to be pushed along the bottom of the storage container into the filling opening.

(Lifting/Pivoting Device:)

Preferably, the filling device has a pivoting device for pivoting a filled collecting trolley into the storage container, in particular a lifting/pivoting device, by means of which the collecting trolley can first be lifted to a corresponding height until it can be emptied by pivoting into the high positioned filling opening of the storage container.

This means that the filled collecting trolley does not have to be emptied manually into the storage container. Instead, this is done automatically and power-savingly by means of the pivoting device, in particular the lifting/pivoting device.

This is preferably designed in such a way that for emptying the collecting trolley is only lifted as little as possible to the top, as it projects far upwards over the filling opening due to pivoting over, and often only a limited height is available at the place of use of this baler

The pivoting device preferably has a ixing device for attaching a collecting trolley, which can be connected to the pivoting device in the lowered position of the pivoting device, for example, by simply contacting and locking it in place, and can then be automatically lifted and emptied.

This means that the collecting trolley only has to be manually brought into contact with the fixing device and, if this does not cause automatic locking, it must be manually fixed to it. Preferably, a sensor monitors whether a collection container is present and/or correctly attached to the fixing device and thus to the pivoting device.

(Storage Pusher:)

In order to transport the material to be pressed from the storage container into the filling opening of the press box, the storage container preferably has a driven storage pusher which can be moved towards and away from the filling opening between two end positions so that this does not have to be done manually either.

In one end position the storage pusher closes the filling opening of the press box and its front surface is then part of the inner surface of the press box and/or the storage pusher is part of the side wall in which the filling opening is located. This keeps the number of components and the weight of the baler low.

In the other end position, the storage pusher is located at the end of the storage container facing away from the filling opening, so that loose material to be pressed can be filled in between.

The storage pusher can either be moved back and forth in the storage container or the front wall of the storage container facing away from the filling opening is itself the storage pusher and can move in transverse direction to the filling opening. This keeps the number of components low.

Preferably, the side walls are then designed to be variable in length, especially multi-part, especially telescopic, but they can also be rigid, one-piece side walls, which then still extend far from the rear of the actual baler when the front wall is moved in the direction of the filling opening.

The storage pusher is usually moved by means of double-sided towing cylinders, preferably running in its direction of movement, or by another storage pusher drive.

A particularly space-saving arrangement is achieved if these towing cylinders run along the outside of the storage container and especially also along the outside of the cross walls of the press box, since they then generally do not protrude further than the storage container itself in any of their possible positions.

Preferably, they are designed as pulling cylinders, i.e. they are designed so that pressure can be applied to them, especially in the direction in which the piston enters the cylinder.

(Cover Flap:)

The storage container has a cover flap so that when the loose material to be pressed in the storage container is pushed forward in the direction of the filling opening, the loose material to be pressed does not pile up above the upper filling opening of the storage container, which is displaceable between a closed position closing the filling opening or in particular the entire open top of the storage container and an open position not closing it, in particular leaving it completely open, so that in this open position the filling opening is available for the filling of loose material to be pressed.

In the closed position, the underside of the cover flap should run parallel to the bottom of the storage container in order to create a channel of constant height, which the storage pusher essentially fills in height in each of its functional positions.

The cover flap may also have a crank or other retaining elements at its free end, i.e. the end facing away from its pivot axis, which are directed towards the inside of the storage container to prevent pressed material from being pushed over the rear edge of the storage container when the cover flap is lowered.

The storage pusher should of course fill the channel created by the closed storage container in the direction of the filling opening, also in the width, as far as possible in all its functional positions.

(Guiding Flap:)

Alternatively, the storage container can include a guidingflap, the underside of which serves as a guide surface for the loose material to be pressed towards the filling opening.

For this purpose, it can be moved, in particular pivoted, between a guide position above the filling opening of the storage container at an angle to the bottom, in which the underside of the guiding flap approaches the bottom of the storage container in the direction of the filling opening, and an open position not overlapping this.

This means that the upper edge of the storage pusher does not touch the underside of the flap or reach close to it, but no significant force is required to press down the flap as with a cover flap. Instead, the reservoir pusher pushes the loose material along the bottom towards the filling opening, whereby the material can pile up over the upper edge of the storage pusher, limited only by the underside of the guiding flap.

By moving the storage pusher back and forward again, a considerable amount of loose material can still be fed into the press chamber in several strokes.

It is recommended to provide a cover element extending from the upper edge of the storage pusher in the direction away from the filling opening to prevent pressed material from falling behind the storage pusher, i.e. on the side facing away from the filling opening.

At least in the guide position, side plates are then preferably provided which, in the guide position, close the free space between the side edges of the guiding flap and the edge of the feed opening of the storage container in order to avoid lateral leakage or protrusion of pressed material.

(Inclined Travel:)

In order to keep the overall height of the filling device as low as possible and to position its filling opening as low as possible for this purpose, the bottom of the storage container can be inclined upward, at least from the end of the bottom area which is located below the filling opening, preferably over its entire length.

Nevertheless, the bottom is a flat surface and rises towards the filling opening, especially towards its lower edge, so that the storage pusher can be moved along the bottom in a linear sliding movement, always keeping the same small distance from the bottom or even touching the bottom. For this purpose, the feed direction of the storage pusher runs parallel to the bottom of the container.

However, it is preferable that the front side of the storage pusher is parallel to the inner surface of the side wall in which the filling opening is located, so that the feed pusher, in its end position in which it is in the filling opening, is part of the corresponding side wall of the press box and its inner surface is aligned with the inner surface of the corresponding side wall.

(Storage Container can be Lifted:)

Alternatively, the storage container can be attached to the press box in a height-adjustable manner and can be lifted to an upper position in which the edge of the bottom of the press box is aligned with or slightly higher than the lower edge of the filling opening in a side wall, especially the rear wall, of the press box.

When the collecting trolley is emtied in, the storage container is then in a lowered position just above the bottom so that the collecting trolley, which is almost upside down, does not project very far upward when it is emptied into the storage container.

(Separate Drives:)

Frequently, not only the at least one press stamp, but also the moving parts of the automatic filling device, i.e. in particular the storage pusher and/or the cover flap and/or the tilting device or lifting/pivoting device and/or, if necessary, the liftable bottom and/or the storage container which can be lifted as a whole, are actuated by means of working cylinders, in particular hydraulic cylinders.

The working cylinders of the automatic filling device, in particular its towing cylinders, can be operated with the same working medium as the pressing cylinder actuating the at least one press stamp and can also be supplied with pressure medium from the same pressure medium source.

Preferably, however, the filling device and the press stamp should be operable independently of each other, in particular partially overlapping in time, and for this purpose there are preferably two separate and/or separately controllable drives for the at least one press stamp on the one hand and at least one or some movable parts of the filling device on the other hand, in particular two independently controllable hydraulic pumps.

(Strapping Device:)

Preferably, the box baler according to the invention also has a strapping device to tightly strap the finished bale with a flexible strapping material, for example a strapping band or a binding wire, before it is removed from the baler, thus preventing the pressed bale from being re-enlarged or even falling apart.

In the context of the present invention, only a binding wire is mentioned, without limiting the strapping material to this.

Preferably, such a strapping device comprises at least one wire pusher capable of pushing the binding wire, in particular its end, which may be designed as a wire lug, between the press stamp and the top of the bale from the back to the front side of the press box.

With regard to the operating method for operating a vertically acting box baler, in particular a vertically acting box baler as described above, this object is solved by carrying out the automatic filling of the baler or its press box in batches.

This means that if a batch of loose material to be pressed accumulates, work can be carried out with very little personnel effort. The loose pre material to be pressed is automatically forced through the filling opening into the press box, in particular pushed in, until the entire batch of material to be pressed is inside the press box.

(Via Cover Flap or Guiding Flap:)

Preference the loose material to be pressed before or during pushing into the press box, is compressed in height to a height equal to or less than the height of the press box filling opening.

This allows the pre-compressed material to be moved through the filling opening into the press box without any further measures, for example by pushing it into the press box.

(Keep Width:)

For the same reason, it is preferably also necessary that the loose material to be pressed is either distributed over a width on the bottom of the storage container equal to or smaller than the width of the filling opening of the storage container before being pushed into the press box, or is compressed to a width smaller than the width of the filling opening before or during pushing into the press box.

(Filling During Pressing:)

In order to increase the process flow of the baler, the next filling is preferably prepared while the material is being pressed in the press box. For this purpose, preferably at least the emptied collecting trolley is moved back by the pivoting device into the docking position, in which it stands on the ground and can be released from the pivoting device, in particular a new, filled collecting trolley can already be attached to the pivoting device.

While the bale is being pressed, the storage container of the filling device can also be refilled, if necessary, because the storage pusher can already be moved back from its forward end position, in which it is part of a side wall of the press box, as soon as the press stamp has passed the filling opening and continues to move forwards downwards, and even more so while it then moves back to its upper starting position.

If necessary, the storage container can even be refilled if the storage pusher has not yet reached its starting position furthest away from the filling opening of the press box , whereby the space on the side facing away from the front surface of the storage pusher, which is part of the side wall of the press box during compaction, must be covered at the top to prevent material from falling into this area.

(Diagonal Drive:)

In order to be able to fill the storage container at the lowest possible height, the loose material to be pressed is pushed up to the height of the filling opening before being pushed into the press box.

(Lift the Storage Container:)

Alternatively, the material to be pressed can be lifted up to the height of the filling opening before being pressed into the press box, especially together with the storage container in which it is located.

(Strapping:)

In order to be able to strap the bale even with the baler embodiment according to the invention—whereby the binding wire must not run in front of the filling opening of the press box during the production of the bale—the binding wire, in particular its end, can be arranged in the press box at a height which corresponds approximately to the height of the upper end of the finished bale.

Then, after completion of the bale and while the press stamp is still under pressure on the bale, the wire, in particular the wire lug, can be pushed or pulled through the bale chamber from the back to the front, for example between the press stamp and the upper end of the bale, so that it is accessible at the front end of the press box—with the removal door open—and is available for connecting to the other end of the binding wire which is guided around the bottom of the bale and inserted into the bale box before the production of the bale begins.

c) Exemplary Embodiments

Types of execution according to the invention are described in more detail below as examples.

Shown are:

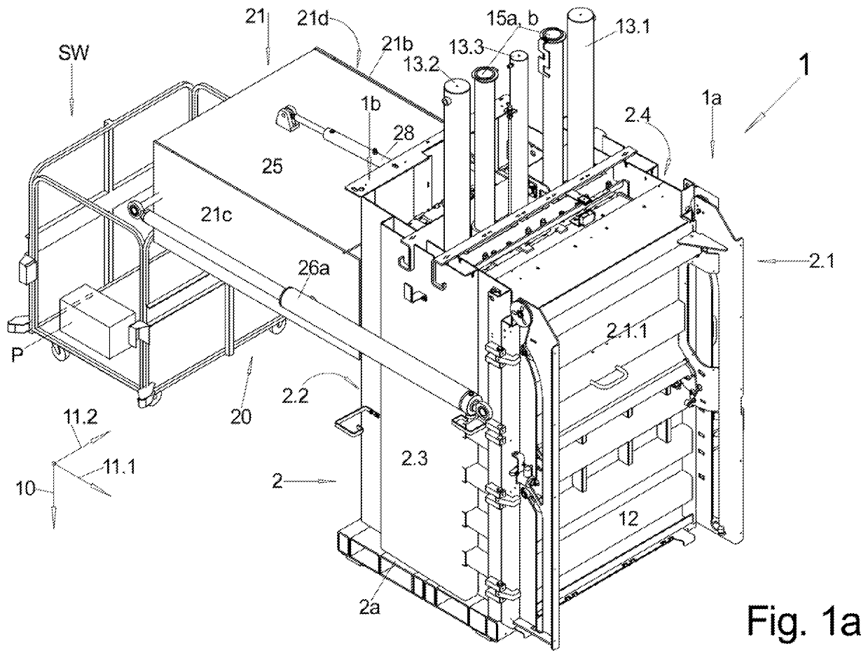

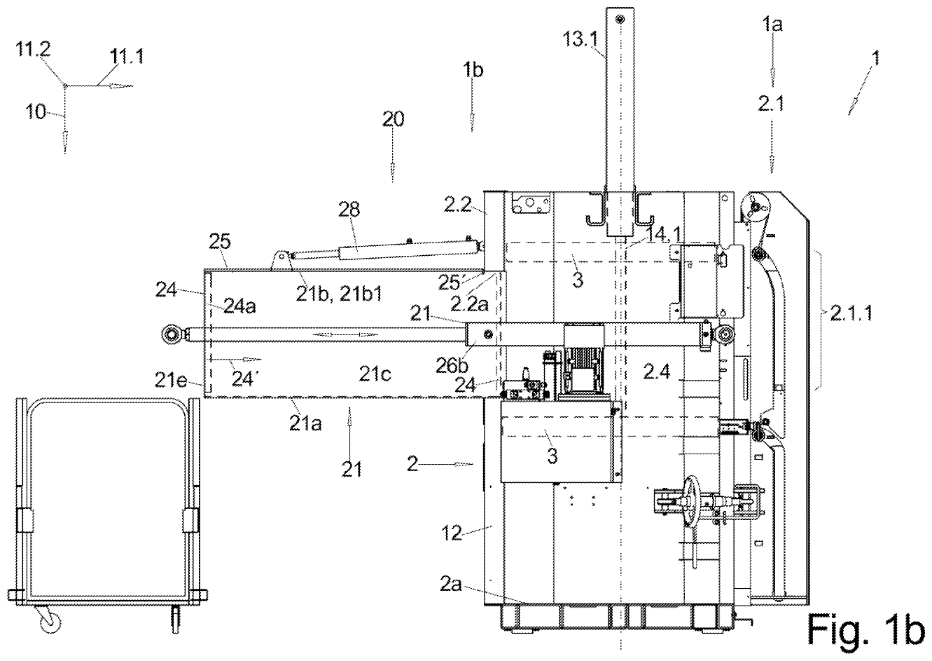

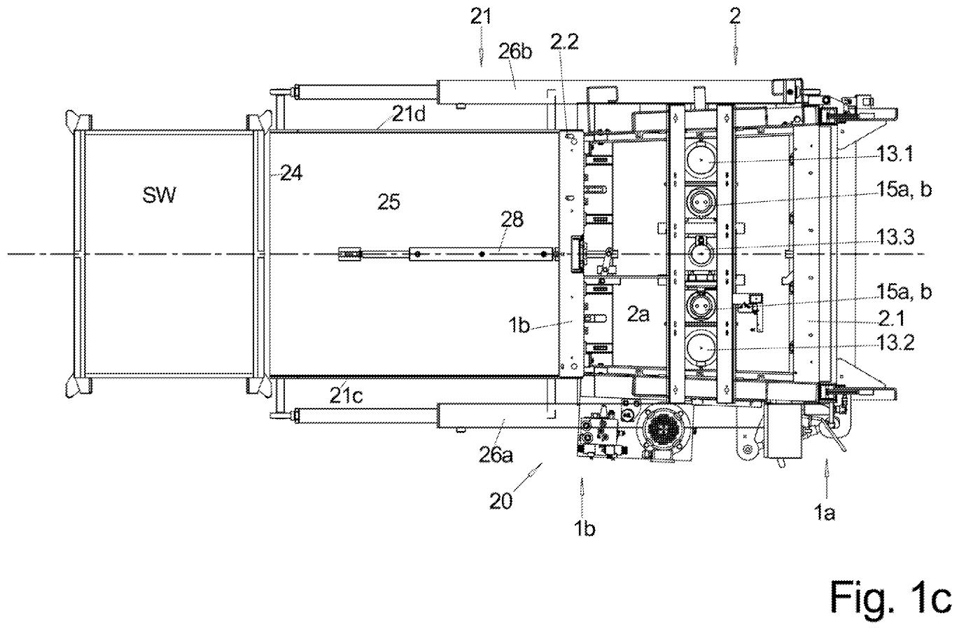

FIG. 1a: a first embodiment of a baler according to the invention in perspective view,

FIG. 1b: the baler of figure 1a in side view,

FIG. 1c: the baler according to figure 1a in top view with the cover flap of the storage container closed,

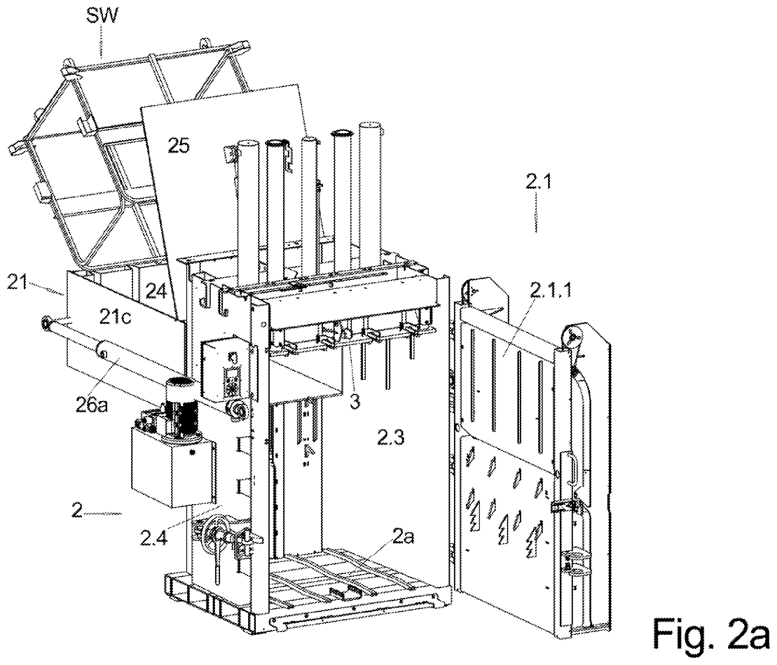

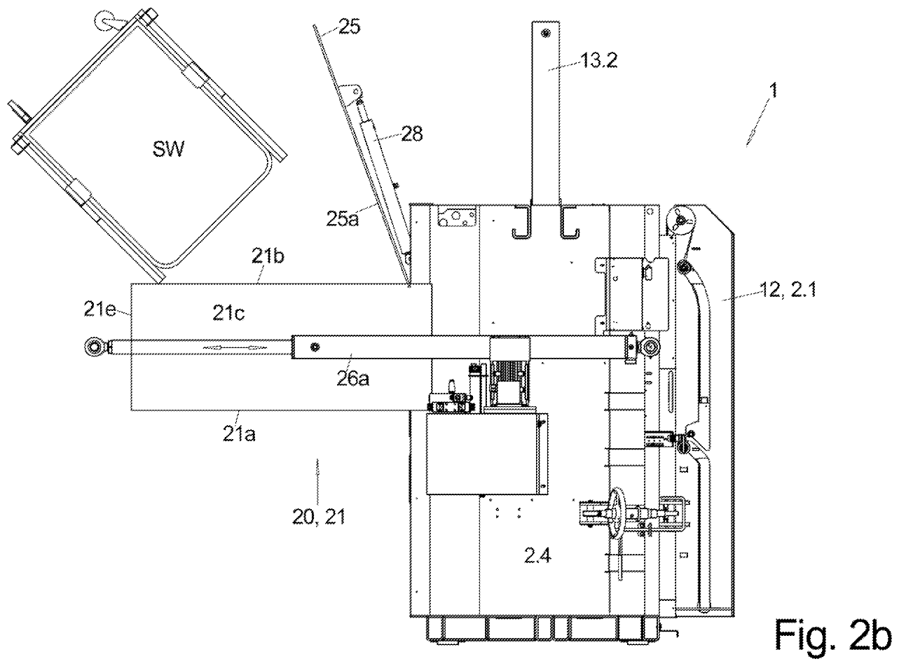

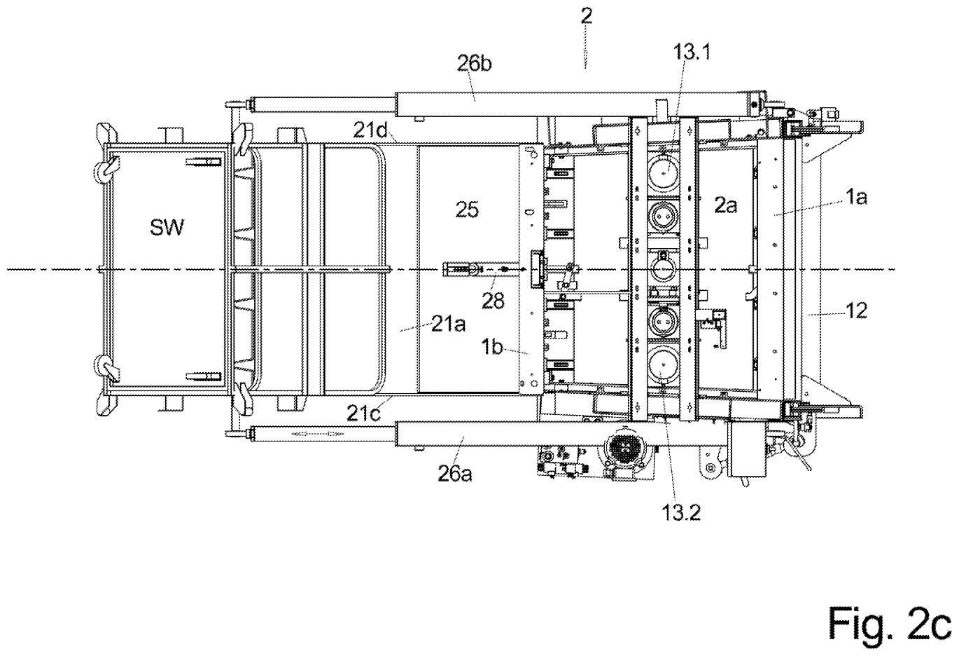

FIG. 2a: the baler of FIG. 1 while filling the storage container, but with the removal door open, in perspective view,

FIG. 2b: the baler as shown in FIG. 2a, but with the removal door closed, in side view,

FIG. 2c: the baler as shown in FIG. 2b, viewed from above,

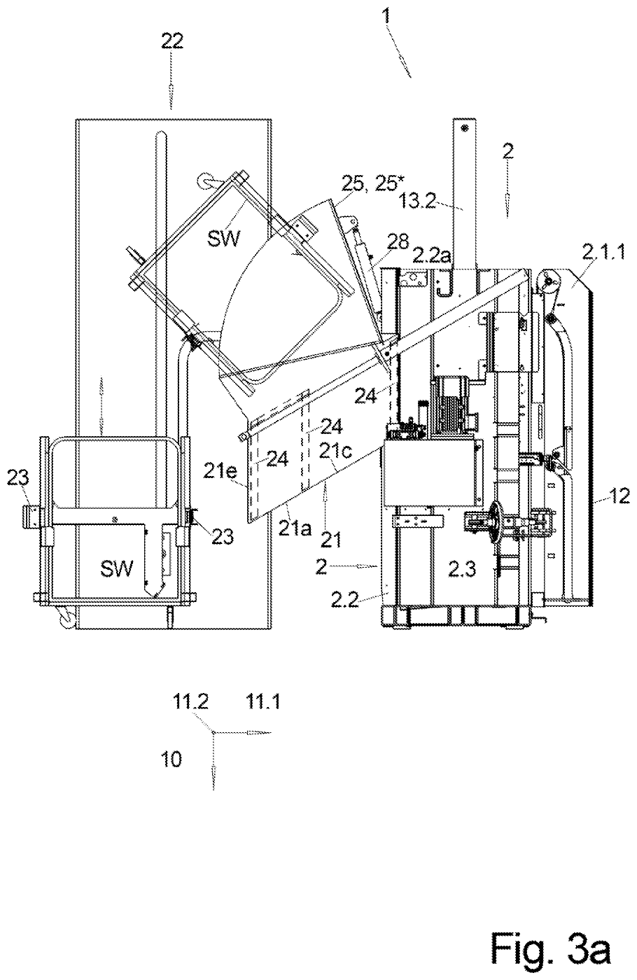

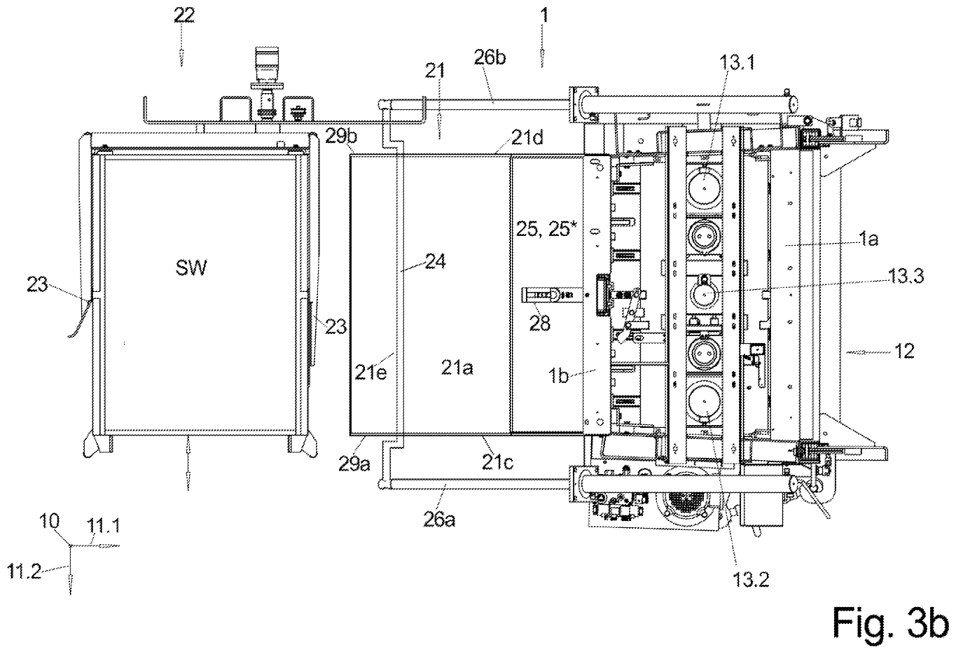

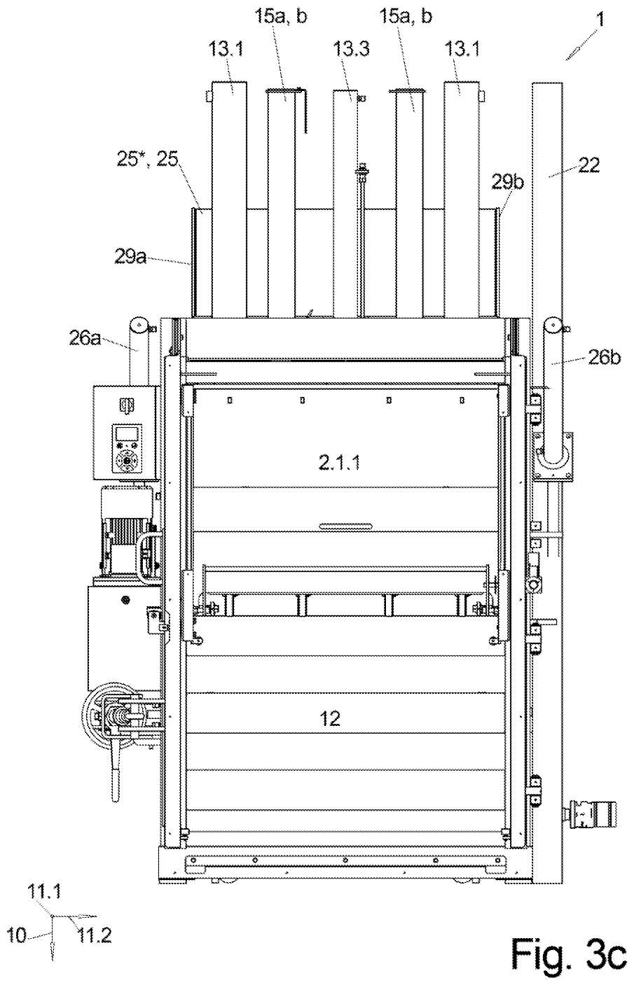

FIG. 3a-c: a second embodiment of a baler according to the invention in side view, top view and front view.

FIGS. 1a-c as well as 2a-c show a first embodiment of the inventive box baler 1 as well as a collecting trolley SW, in which material Pto be pressed such as empty cardboard boxes are collected for feeding this baler 1, but in FIG. 1 on the one hand and FIG. 2 on the other hand in two different operating situations.

In the FIGS. , the box baler 1 points with its front side 1a to the right and with its rear side 1b to the left.

A standard vertical boxe baler comprises—and these elements are also present in the baler according to the invention—a press box 2 with a bottom 2a, which in this case has a roughly rectangular shape when viewed from above, so that a total of four side walls 2.1 to 2.4 project upwards from its outer area, namely a front wall 2.1, a rear wall 2.2 opposite thereto, and longitudinal walls 2.3, 2.4 connecting these two walls to one another, so that the inner surfaces of the side walls, which are adjacent to one another, form a circumferential closed rectangle when viewed in plan.

In the press box 2—as best seen in FIGS. 1b and 2b—a press stamp 3 in the form of a plate lying horizontally and thus parallel to the bottom 2a of the press chamber 2 can be moved up and down in the vertical, the pressing direction 10, which can press the material P lying in the press box against the bottom 2a.

The press stamp 3 is attached to the lower ends of the piston rods 14.1-14.3 by several press cylinders 13.1 to 13.3, which are hydraulic cylinders and are located vertically in the second horizontal transverse direction 11.2, spaced next to each other and projecting beyond the upper end of the press box 2.

To apply high pressing forces, the two outer pressing cylinders 13.1 and 13.2 are extending downwards, while the middle pressing cylinder 13.3 with its smaller cross section is used as a rapid motion cylinder, for example to move the press stamp 3 quickly upwards back to the deactivated position.

Between each of the vertically running press cylinders 13.1 to 13.3, which are arranged parallel to each other in a common plane, there is a guide rod 15a, b, whose lower ends are also firmly connected to the press stamp 3 and are intended to prevent an inclined position and thus tilting of the press stamp 3 in the press box 2.

The front wall 2.1 at the front side 1a is hinged to one of the longitudinal walls 2.3 via a vertical pivot axis and can be swung open like a door—as shown in FIG. 2a—to remove a finished bale.

For pressing, the press stamp 3 moves downwards to the height of the lower end of the filling flap 2.1.1 and thus of the front filling opening, so that a finished bale has a height which also only reaches approximately the lower end of this filling flap 2.1.1.

As best shown in FIG. 1b, the press stamp 3 can be retracted upwards to at least the upper end of the front filling opening, i.e. the upper edge of the filling flap 2.1.1, because the insertion of material to be pressed P must be done into the space below the press stamp 3.

In a vertical box baler of the known type, the rear wall 2.2 of the press box 2 is closed or, if strapping of the finished bales is intended, has at most slits for the strapping medium to pass through. The rear wall 2.2 is preferably manufactured as a one-piece welded part, and the press box 2 is filled with material P from the front side 1a by inserting the upper part as a filling flap 2 in the movable front wall 2.1, which thus forms a removal door 12, which is movably attached to the rest of the front door 2.1 and can be moved downwards along guides so that a filling opening is open in the upper part of the front wall 2.1, through which material to be pressed can be inserted from the front side 1a.

the box baling press 1 according to the invention, which also operates vertically, has a filling opening 2.2a in the upper area of the rear wall 2.2, through which it can be filled automatically according to the invention.

The filling opening to be opened in the front wall 2.1, formed as described by the embodiment of a filling flap 2.1.1 in the removal door 2.1, can be additionally present, but this is not a prerequisite for the realization of the invention. The front wall 2.1 can be a closed removal door 12, which can only be moved as a door in total.

The automatic filling is carried out by means of a filling device 20, which comprises a box-shaped storage container 21, which is joined to the outside to the rear wall 2.2 of the press box 2 and has a horizontally extending bottom 21a in FIGS. 1 and 2, from which side walls 21c, d and at the free end an end wall 21e project, the side walls reaching up to the filling opening 2.2a in the rear of the press box 2.

The upper side 21b of the storage container 21 can be closed by a cover flap 25, which can be pivoted about a horizontally extending pivot axis 25′ near the press box 2 between the pivoted down position of the cover flap 25, in which the upper side 21b is closed and the lower side of the cover flap 25 runs parallel to the bottom 21a of the storage container 21, and a filling position pivoted upwards—as shown in FIG. 2—by means of a pivot cylinder 28.

In this filling position, a collecting trolley SW filled with material P to be pressed, which is open at the top, can be swung up and emptied into the storage container 21 via the upper edge of the end wall 21e of the storage container 21.

Lifting, pivoting, emptying, pivoting back and setting down the collecting trolley SW is usually done automatically by means of a lifting/pivoting device 22 as shown and described in FIGS. 3a-c.

After the collecting trolley SW has been swung back, the cover flap 25 can be closed again with the aid of the pivot cylinder 28, whereby the pivot cylinder 28 can provide sufficient pivot force that loose material P to be pressed projecting above the height of the upper edge of the end wall 21e is compressed by the underside 25a of the cover flap 25 below this level.

Inside the storage container 21a storage pusher 24 can be moved between a retracted position near the end wall 21e and an advanced or forward position near the filling opening 2.2a of the press box 2, whereby the storage pusher24 moves with its lower edge close to the bottom 21a.

In the advanced end position—see FIG. 1b —the storage pusher 24 is preferably not only located near the filling opening 2.2a, but in this filling opening 2.2a, which it closes completely so that it becomes part of the rear wall 2.2 of the press box 2 and its front surface facing the press box 2 is flush with the inner surface of the remaining rear wall 2.2.

The storage pusher24 is moved by means of two towing cylinders 26a, b, which move along the outer sides of the side walls 21c, d of the storage container 21 and also along the longitudinal walls 2.3, 2.4 of the press box 2 in the first horizontal cross direction 11.1, one end of each towing cylinder 26a, b being connected to one of the longitudinal walls 2.3, 2.4 in the vicinity of the front wall 2.1, while the other end is connected to the storage pusher24 through the side wall 21c, d of the storage container 21.

The towing cylinders 26a, b are preferably designed as double-acting hydraulic cylinders that can be actuated in both directions.

In the embodiment of FIGS. 1 and 2, the bottom 21a of the storage container 21 runs horizontally, i.e. at right angles to the rear wall 2.2, and the plate-shaped storage pusher 24 stands at a right angle to the bottom 21a and thus vertically, and completely fills the cross-section of the storage container 21, i.e. at right angle to the extension direction of the towing cylinders 26a, b, the pushing direction 24′ of the storage pusher 24, so that no material P to be pressed can get in between.

Because in such a embodiment during filling, as can be seen in FIG. 2a, b, the raised and pivoted collecting trolley SW protrudes beyond the baler 1 and thus requires a large available height at the place of use, FIGS. 3a-c show a second embodiment of a baler 1 in which this required height is less, in particular not greater, than the height of the vertical box baler 1 itself:

The main difference compared to the first embodiment of FIGS. 1 and 2 is that the bottom 2.1a of the storage container 21 does not run horizontally, but rises at an angle to the rear filling opening 2.2a in the rear wall 2.2 of the press box 2.

As a result, its free end facing away from the bale chamber 2, i.e. also the end wall 21e and its upper edge, is considerably lower than in the first embodiment, so that the collecting trolley SW has to be lifted less far up over this upper edge for emptying and thus also projects less far upwards in its—in FIG. 3a also shown—emptying position, hardly above the height level of the upper end of the remaining baler, in particular the upper ends of the press cylinders 13.1-13.3.

As FIG. 3a shows, the end wall 21e of the storage container 21 is still vertical, and so is the storage pusher 24, which is located in it like in the first embodiment, but the pushing direction 24′ of the storage pusher 24 is no longer horizontal but runs diagonally rising parallel to the bottom 21a of the storage container 21.

5

The remaining embodiment of the baler 1 corresponds to the first embodiment of FIGS. 1 and 2, but FIGS. 3a-3c additionally show the lifting/pivoting device 22, which lifts the filled collecting trolley SW, which has been driven up on the ground and fixed in it, and pivots it into the correct position and empties it into the storage container 21.

For this purpose, the collection trolley SW is coupled to the lifting/tipping device 22 by means of a fastening device 23 of the lifting/pivoting device 22, which in this case—as shown in FIG. 3b—has a U-shaped fork as seen in plan view, into which the collecting trolley SW can be driven in the 2nd transverse direction 11.2 and is locked there automatically or manually. This U-shaped fork is then lifted and pivoted by motor along corresponding guides of the lifting/pivoting device 22 together with the collecting trolley SW.

Furthermore, FIGS. 3a-c contain the side plates 29a, b, which can best seen in FIG. 3a and are optionally available. These plates are aligned or parallel to the side walls 21c, d of the storage container 21 and extend them upwards, thus increasing the filling volume of the storage container 21. The cover flap 25 pivots between the open position shown in FIG. 3a—in which it usually only slightly covers the open top of the storage container 21—with its side edges tightly fitting between the side plates 29a, b downwards to the lower end position.

When used as cover flap 25, this lower end position is an end position parallel to the bottom 21a, in which the distance between the closed cover flap 25 and the bottom 21a remains the same over the entire displacement path of the storage pusher 24, in particular until the latter has reached its end position in the filling opening 2.2a, where it becomes part of the corresponding side wall 2.2.

However, if the side plates 29a, b are present, the cover flap 25 can also be used as guiding flap 25*, which means that the lower end position is not an end position parallel to the bottom 21a, but a position inclined to the bottom, in which the distance between the guiding flap 25* located in this end position and the bottom 21a of the storage container 21 decreases from the free end wall 21b in the direction of the filling opening 2.2a.

If, in this operating mode, the storage pusher 24 moves from its retracted end position in the direction of the filling opening 2.2a, material can pass over the upper edge of the storage pusher 24, which is why a cover element 27, which can be adjusted in length or moved, is provided from the upper end of the storage pusher 24 to the upper edge of the free end wall 21b.

In order to push the entire filled material to be presses into the press box 2 in this mode of operation, several working strokes of the storage pusher 24 may be necessary, however, the pivot cylinder 28 for the cover flap or guiding flap must be made less strong for this purpose and/or a higher filling volume in relation to a lower volume of the storage container 21 can be handled during a filling process.

### LIST OF REFERENCE SIGNS

1 box baler
1a front side
1b rear side
2 press box
2a bottom
2.1 side wall, front wall
2.1.1 filling flap
2.1a removal opening
2.2 side wall, rear wall
2.2a filling opening
2.3, 2.4 side wall, longitudinal wall
3 press stamp
10 press direction, vertical
11.1 cross direction, process flow direction
11.2 cross direction
12 removal door
13.1-13.3 press cylinder
14.1-14.2 piston rod
15a, b guide rod
20 filling device
21 storage container
21a bottom
21b upper side
21b 1 filling opening,
21c, d side wall
21e end wall
22 pivoting device, lifting/pivoting device
23 fixing device
24 storage pusher
24′ movement direction, pushing direction
24a front surface, pushing surface
25 cover flap
25′ pivot axis
25* guiding flap
25a underside
26a, b towing cylinder
27 cover element
28 pivot cylinder
29a, b side panel
P material to be pressed
SW collecting trolley

In the claims:

1. A vertical box baler comprising:
a press box (2) with a bottom (2a) and side walls (2.1-2.4) projecting upward from the bottom (2a),
a press stamp (3) that can be moved up and down in the press chamber (2),
a closable removal opening (2.1a) in the front wall (2.1),
a closable filling opening (2.2a), in one of the other side walls in their upper area,
a filling device (20) for automatic filling of the press box (2) through the filling opening (2.2a),
characterized in that
the filling device (20) is configured for automatic batchwise filling of the press box (2).

2. The box baler according to claim 1, characterized in that
the filling device (20) comprises a storage container (21) for receiving loose material (P) to be pressed, which comprises a filling opening (21b1), in the upper region, in the top side (21b), of the storage container (21), in that the top side (21b) is completely open,
the storage container (21) is connected to the filling opening (2.2a), wherein the bottom (21a) of the storage container (21) extends up to the filling opening (2.2a) and ends at its height or above it, and adjoining it.

3. The box baler according to claim 1, characterized in that
the storage container (21) has a sufficiently large volume to hold a complete batch with a predetermined volume of loose material (P) to be pressed,
the preset volume of a complete batch corresponds to the volume of a collecting trolley (SW) for loose pressed material (P) to be pressed.

4. The box baler according to claim 1, characterized in that
the filling device (20) comprises a lifting/pivoting device (22), for automatically pivoting a filled collecting trolley (SW) into the storage container (21),
the pivoting device (22) comprises a fixing device (23) for fixing a collecting trolley (SW) to the pivoting device (22).

5. The box baler according to claim 1, characterized in that
the storage container (21) comprises a storage pusher (24), which is movable towards and away from the filling opening (2.2a) between two end positions,
wherein in one end position the storage pusher (24) closes the filling opening (2.2a) of the press box (2) and its front surface (24a) is a component of the inner surface of one of the walls (2.2-2.4) of the press box (2) or in one end position the storage pusher (24) is a component of that side wall (2.2) in which the filling opening (2.2a) is located,
wherein in the other end position, the storage pusher (24) is located at the end of the storage container (21) facing away from the filling opening (2.2a).

6. The box baler according to claim 5, characterized in that
the storage pusher (24)
can either be moved back and forth in the storage container (21),
or the end wall (21.1) of the storage container (21) facing away from the filling opening (2.2a) is the storage pusher (24) and the side walls (21.2, 21.3) are designed to be variable in length, multi-part, telescopic.

7. The box baler according to claim 1, characterized in that
the storage pusher (24) is moved by means of towing cylinders (26a, b) on both sides, preferably running in its direction of movement,
which run along the outside of the storage container (21)
and along the outside of the cross walls (2.3, 2.4) of the press box (2), or
the towing cylinders (26a, b) are designed as pulling cylinders.

8. The box baler according to claim 5, characterized in that
the storage pusher of the filling device (20), on the one hand, and the at least one press stamp (3), on the other hand, have separate drives and can be actuated independently of one another
with hydraulic drive in each case, there are two separate and independently controllable hydraulic pump pressure sources.

9. The box baler according to claim 1, characterized in that
the storage container (21) comprises a cover flap (25) which can be displaced, and pivoted, between a closed position closing the filling opening (21b1), the open top side (21b), of the storage container (21) and an open position not closing it, leaving it completely open,
the volume of the storage container (21) in the closed position of the cover flap (25) is less than the predetermined volume of a batch,
in the closed position, the underside (25a) of the cover flap (25) runs parallel to the bottom (21a) of the storage container (21), or
the cover flap (25) has a bendat its free side remote from its pivot axis (25′) in the direction into the storage container (21).

10. The box baler according to claim 9, characterized in that
the cover flap (25) can be used as a guiding flap (25*) which can be displaced, and pivoted, between a guide position, which is inclined relative to the bottom (21a) above the openupper side (21b) of the storage container (21), and an open position, which overlaps the guide position less,
in the guide position, the bottom (25*a) of the guiding flap (25*) approaches the bottom (21a) of the storage container (21) in the direction of the filling opening (2.2a),
in particular side plates (29a, b) are provided which, in the guide position, close the free space between the side edges of the guiding flap (25*) and the edge of the open upper side (21b) of the storage container (21).

11. The box baler according to claim 5, characterized in that
there is a cover element (27) which extends from the upper edge of the storage pusher (24) in the direction away from the filling opening (2.2a) and which closes the surface, viewed in plan view, between the rear side of the storage pusher (24) and the part of the storage container (21) adjacent thereto.

12. The box baler according to claim 2, characterized in that
the bottom (21a) of the storage container (21) rises at an angle to the top, as a flat surface, towards the filling opening (2.2a), towards its lower edge,
the pushing direction (24′) of the reservoir pusher (24) is parallel to the bottom (21a) of the storage container (21),
the front side (24a) of the storage pusher (24) is arranged parallel to the inner surface of that side wall (2.2) in which the filling opening (2.2a) is located.

13. The box baler according to claim 2, characterized in that
the storage container (21) is attached to the press box (2) so that it can be moved vertically up to an upper position in which the box-side edge of the bottom (21a) is aligned with the lower edge of the filling opening (2.2a) or higher.

14. The box baler according to claim 1, characterized in that
the box baler comprises a strapping device for strapping the finished bale in the box baler, motorized or automatic, with binding wire,
the strapping device has at least one wire pusher which is capable of pushing the wire, at its end, its wire lug, between the bale and the press stamp (3) from the rear to the front of the press box (2).

15. A method operating a box baler, in particular a box baler according to claim 1,
wherein the press box (2) is filled automatically,
characterized in that
the press box (2) is automatically filled in batches.

16. The method according to claim 15, characterized in that
the material to be pressed (P) is automatically towed, and pushed, through the filling opening (2.2a) into the press box (2).

17. The method according to claim 15,
characterized in that
the material to be pressed (P) is compressed in height, i.e. pre-compressed, through the filling opening (2.2a) before or during pressing into the press box (2) to a height equal to or less than the height of the filling opening (2.2a).

18. The method according to claim 15,
characterized in that the loose material to be pressed (P) before being towed into the press box (2) through the filling opening (2.2a),
either distributed over a smaller width considered in the top view than the width of the filling opening (2.2a)
or before or during towing into the press box (2) through the filling opening (2.2a) is compressed in width to a width that is smaller than the width of the filling opening (2.2a).

19. The method according to claim 15 characterized in that
during the pressing of the material to be pressed (P) in the press box (2)
another collecting trolley (SW) can be moved back into the docking position by the pivoting device (22),
a new, filled collecting trolley (SW) can be attached to the pivoting device (22), or
the storage container (21) of the filling device (20) can already be filled again with material (P) to be pressed.

20. The method according to claim 15, characterized in that
the loose material to be pressed (P) is pushed upwards through the filling opening (2.2a) up to the height of the filling opening (2.2a) before being towed into the press box (2).

21. The method according to claim 15, characterized in that
the loose material to be pressed (P) is lifted up to the level of the filling opening (2.2a) before being towed into the press chamber (2) through the filling opening (2.2a).

22. The method according to claim 15, characterized in that
the finished bale is strapped with binding wire before being removed from the box baler,
for which purpose the at least one binding wire, its end in the form of a wire lug, introduced into the press box (2) before production of the bale, is pushed between the bale and the press stamp (3), automatically, from the rear to the front of the press box (2), into a position accessible when the removal door (12) is open,
so that afterwards the other end of the binding wire can be connected to it.
